(19) United States
(12) Patent Application Publication
(10) Pub. No.: US 2013/0145060 A1
(43) Pub. Date: Jun. 6, 2013

(54) SIGNAL COLLECTION SYSTEM AND METHOD WITH SIGNAL DELAY

(71) Applicant: LI-WEN GUO, Shenzhen City (CN)

(72) Inventor: LI-WEN GUO, Shenzhen City (CN)

(73) Assignees: HON HAI PRECISION INDUSTRY, Tu-Cheng (TW); HONG FU JIN PRECISION INDUSTRY(ShenZhen) CO., LTD., Shenzhen City (CN)

(21) Appl. No.: 13/598,764

(22) Filed: Aug. 30, 2012

(30) Foreign Application Priority Data
Dec. 1, 2011 (CN) 201110392212.5

(51) Int. Cl. G06F 3/00

(52) U.S. Cl. 710/58

(57) ABSTRACT

An exemplary signal collection system includes a signal transmitting module, a computer, and a data collection card. The signal transmitting module includes a signal source and a delay chip. The delay chip receives a first path high-speed signal output from the signal source and transmits the first path high-speed signal to the data collection card in real time. The computer sends a delay command to the data collection card and the data collection card transfers the delay command to the delay chip. The delay chip generates a second path high-speed signal by delaying the first path high-speed signal in response to the delay command and transmits the second path high-speed signal to the data collection card. The data collection card transmits the high-speed signals output from the delay chip to the computer. A signal collection method based upon the signal collection system is also provided.

### CROSS-REFERENCE TO RELATED APPLICATIONS

This application claims all benefits accruing under 35 U.S.C. §119 from China Patent Application No. 201110392212.5, filed on Dec. 1, 2011 in the State Intellectual Property Office of China. The contents of the China Application are hereby incorporated by reference. In addition, subject matter relevant to this application is disclosed in: co-pending U.S. patent application entitled “SIGNAL COLLECTION SYSTEM WITH FREQUENCY REDUCTION UNIT AND SIGNAL COLLECTION METHOD,” Attorney Docket Number US41879, application No. [to be advised], filed on the same day as the present application; co-pending U.S. patent application entitled “SIGNAL COLLECTION SYSTEM AND METHOD WITH SIGNAL DELAY,” Attorney Docket Number US41880, application No. [to be advised], filed on the same day as the present application; and co-pending U.S. patent application entitled “SIGNAL COLLECTION SYSTEM WITH FREQUENCY REDUCTION MODULE AND SIGNAL COLLECTION METHOD,” Attorney Docket Number US41882, application No. [to be advised], filed on the same day as the present application. This application and the three co-pending U.S. patent applications are commonly owned, and the contents of the three co-pending U.S. patent applications are hereby incorporated by reference.

### BACKGROUND

1. Technical Field

The disclosure generally relates to signal collection systems and methods, and particularly relates to high-speed signal collection systems and methods.

2. Description of Related Art

In quantum communication systems or other high-speed communication systems, multi-path high-speed signals are oftentimes transmitted simultaneously in order to increase data transmission speed and improve data throughput. However, the high-speed signals transmitted in this way often result in signal distortion and low accuracy of data collection.

Therefore, there is a need to provide a high-accuracy signal collection system and method for processing high-speed signals.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of a signal collection system according to one embodiment.

FIG. 2 is a detailed functional block diagram of the signal collection system of FIG. 1.

FIG. 3 is a flowchart showing one embodiment of a method for signal collection using the signal collection system of FIG. 2.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

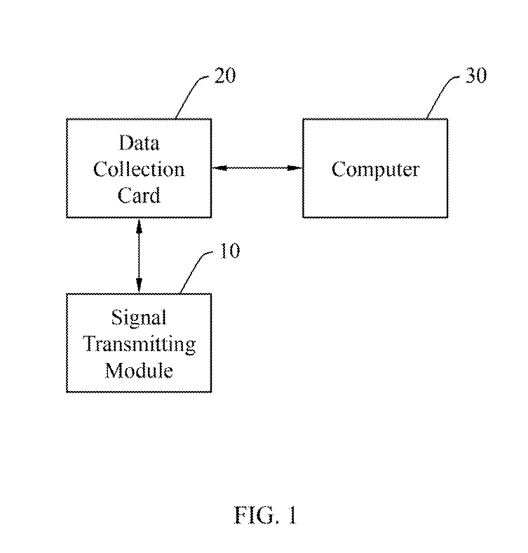

FIG. 1 shows a signal collection system according to one embodiment. The signal collection system includes a signal transmitting module 10, a data collection card 20, and a computer 30. The data collection card 20 interconnects the signal transmitting module 10 and the computer 30. The signal transmitting module 10 may generate and output high-speed signals. In this description, a “high-speed” signal may be considered to be a signal that transmits at a speed of anywhere between, for example, 500 kilobits per second and 30 Megabits per second. The data collection card 20 may collect the high-speed signals output from the signal transmitting module 10, and transmit the high-speed signals to the computer 30. The computer 30 may store and process the high-speed signals transmitted from the data collection card 20.

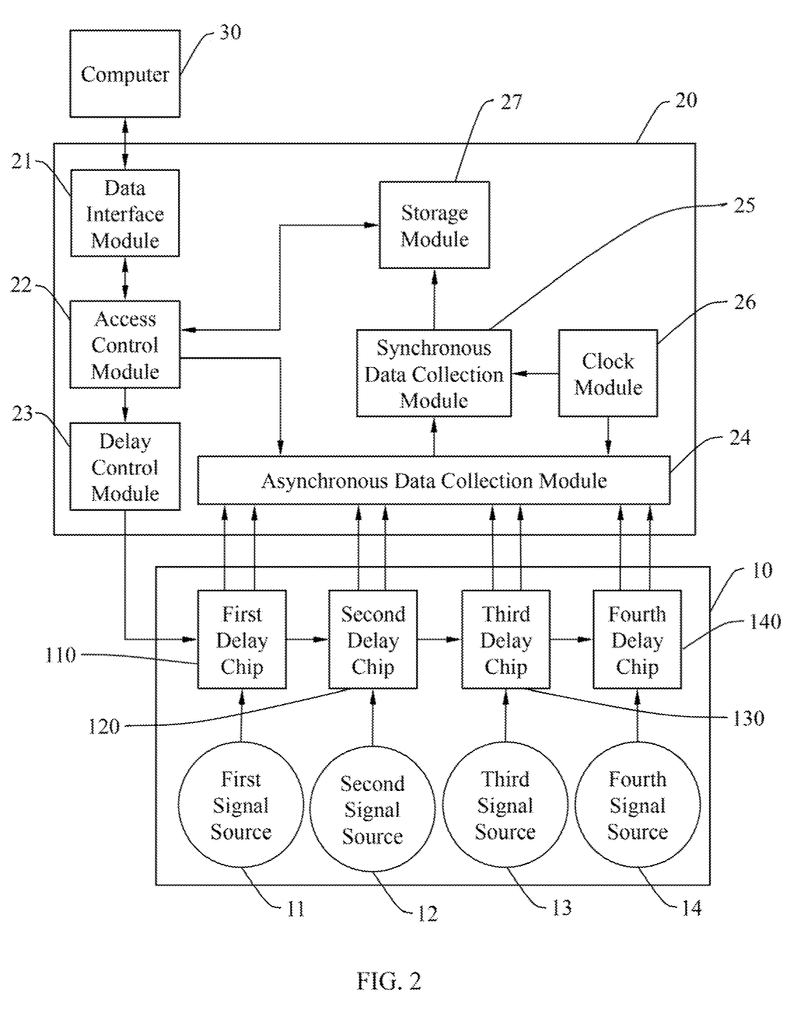

In some embodiments, the signal transmitting module 10 includes multiple signal sources that may generate and output multi-path high-speed signals. Referring to FIG. 2, the signal transmitting module 10 includes a first signal source 11, a second signal source 12, a third signal source 13, a fourth signal source 14, a first delay chip 110, a second delay chip 120, a third delay chip 130, and a fourth delay chip 140. Each of the four signal sources 11 to 14 of the signal transmitting module 10 may generate and output a high-speed signal.

Each of the four delay chips 110 to 140 is connected to a respective one of the four signal sources 11 to 14, and may accept and delay the high-speed signal generated by its respective signal source 11, 12, 13 or 14. The four delay chips 110 to 140 may output the multi-path high-speed signals to the data collection card 20 in real time, and further output the delayed high-speed signals to the data collection card 20.

Taking the first delay chip 110 as an example, the first delay chip 110 is connected to the first signal source 11. The first signal source 11 may generate a first path high-speed signal, and output the first path high-speed signal to the first delay chip 10. The first delay chip 10 may transmit the first path high-speed signal to the data collection card 20 in real time. In the meantime, the first delay chip 10 may generate a second path high-speed signal by delaying the first path high-speed signal output from the first signal source 11, and transmit the second path high-speed signal to the data collection card 20. Thus, the data collection card 20 may receive both the first path high-speed signal and the second path high-speed signal. In FIG. 2, one of the twin arrows leading directly up from the first delay chip 110 to the data collection card 20 represents transmission of the first path high-speed signal, and the other of the twin arrows leading directly up from the first delay chip 110 to the data collection card 20 represents transmission of the second path high-speed signal. The second delay chip 12, the third delay chip 13, and the fourth delay chip 14 are adapted to function in a similar way as the first delay chip 11.

The data collection card 20 includes a data interface module 21, an access control module 22, a delay control module 23, an asynchronous data collection module 24, a synchronous data collection module 25, a clock module 26, and a storage module 27. The data interface module 21 is connected to the computer 30, and may receive various commands from the computer 30. The delay control module 23 is connected to the first delay chip 110. The access control module 22 is connected to the data interface module 21, the delay control module 23, the asynchronous data collection module 24, and the storage module 27.

The data interface module 21 may receive a delay command from the computer 30, and send the delay command to the access control module 22. The access control module 22 may receive the delay command from the data interface module 21, and transmit the delay command to the delay control module 23. The delay control module 23 may receive the delay command from the access control module 22, and transmit the delay command to the first delay chip 10. The first delay chip 110 may receive the delay command from the delay control module 23, and perform a delay operation in response to the delay command. The delay command may further indicate a signal delay time, e.g., 50 milliseconds. The second delay chip 120 is connected to the first delay chip 110, and may receive the delay command from the first delay chip 110. The third delay chip 130 is connected to the second delay chip 120, and may receive the delay command from the second delay chip 120. The fourth delay chip 140 is connected to the third delay chip 130, and may receive the delay command from the third delay chip 130. Each of the four delay chips 110 to 140 may initiate a delay operation in response to the delay command.

The asynchronous data collection module 24 is connected to each of the first to fourth delay chips 110 to 140. The asynchronous data collection module 24 may asynchronously collect the multi-path high-speed signals output from the first to fourth delay chips 110 to 140. The asynchronous collection performed by the asynchronous data collection module 24 does not require a consistent clock time for the first to fourth delay chips 110 to 140 and the asynchronous data collection module 24. Therefore the asynchronous data collection module 24 may receive the high-speed signals even when the multi-path high-speed signals have arbitrary and varying frequencies, and may reduce the potential interference of the multi-path high-speed signals generated from the signal transmitting module 10.

In one embodiment, the data interface module 21 may receive a data collection command from the computer 30, and send the data collection command to the access control module 22. The access control module 22 may receive the data collection command from the data interface module 21, and transmit the data collection command to the asynchronous data collection module 24. The asynchronous data collection module 24 may receive the data collection command from the access control module 22, and asynchronously collect both the real-time high-speed signals and the delayed high-speed signals from the first to fourth delay chips 110 to 140 in response to the data collection command.

The synchronous data collection module 25 is connected to the asynchronous data collection module 24, and may synchronously collect the high-speed signals output from the asynchronous data collection module 24. The synchronous collection performed by the synchronous data collection module 25 requires a consistent clock time for the asynchronous data collection module 24 and the synchronous data collection module 25, and thus may increase the speed of data transmission.

The clock module 26 is connected to each of the asynchronous data collection module 24 and the synchronous data collection module 25. The clock module 26 may generate clock signals with a uniform clock frequency, and output the clock signals to the asynchronous data collection module 24 and the synchronous data collection module 25.

The storage module 27 is connected to the synchronous data collection module 25. The storage module 27 may buffer the high-speed signals output from the synchronous data collection module 25. The access control module 22 may retrieve the buffered high-speed signals from the storage module 27, and transmit the high-speed signals to the data interface module 21. The data interface module 21 may receive the high-speed signals from the access control module 22, and transmit the high-speed signals to the computer 30.

When receiving the high-speed signals output from the data interface module 21, the computer 30 may restore the high-speed signals and extract the information carried by the high-speed signals.

In one embodiment, the data collection card 20 includes a complex programmable logic device (CPLD) or a field programmable gate array (FPGA). The data interface module is a universal asynchronous receiver/transmitter (UART).

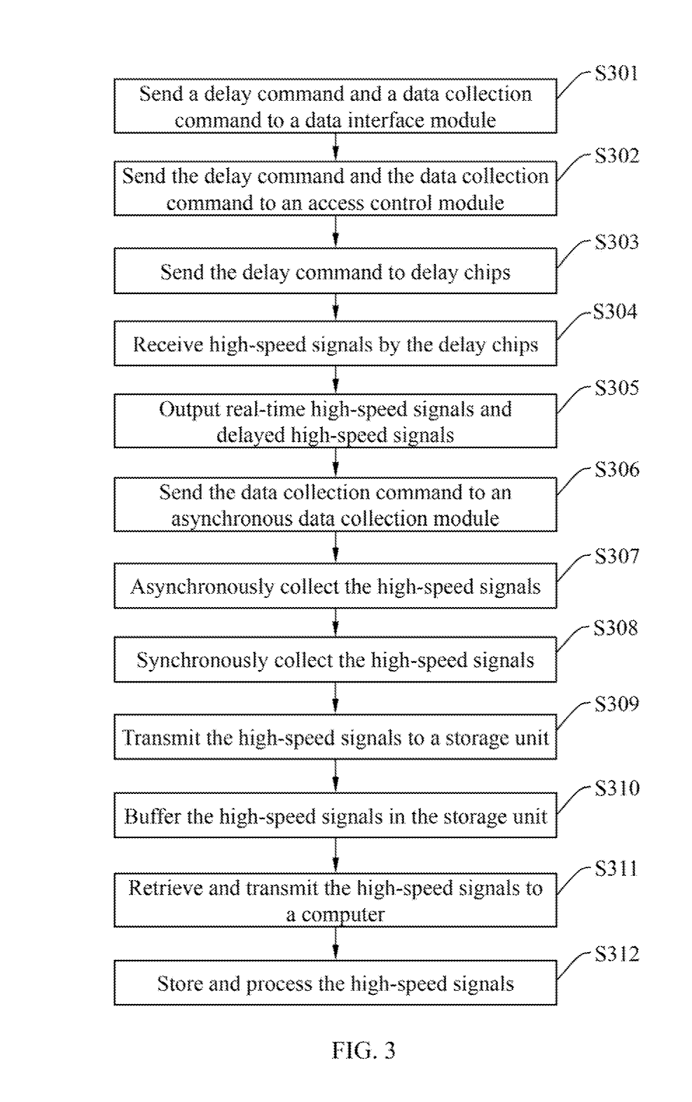

FIG. 3 is a flowchart showing one embodiment of a signal collection method using the signal collection system. The method comprises the following steps.

In step S301, the computer 30 sends a delay command and a data collection command to the data interface module 21.

In step S302, the data interface module 21 sends the delay command and the data collection command to the access control module 22.

In step S303, the access control module 22 sends the delay command to the first to fourth delay chips 110 to 140. In particular, firstly, the access control module 22 sends the delay command to the delay control module 23. The delay control module 25 then sends the delay command to the first delay chip 110. The delay command is then transmitted in chain sequence from the first delay chip 110 to the second, third and fourth delay chips 120, 130, 140, one by one. Thus each of the first to fourth delay chips 110 to 140 receives the delay command.

In step S304, the first to fourth delay chips 110 to 140 receive high-speed signals output from the first to fourth signal sources 11 to 14, respectively.

In step S305, the first to fourth delay chips 110 to 140 output the high-speed signals to the data collection card 20 in real time. The four delay chips 110 to 140 further delay the high-speed signals in response to the delay command and output delayed high-speed signals to the data collection card 20. Taking the first delay chip 110 as an example, the first delay chip 110 receives a first path high-speed signal from the first signal source 11. The first delay chip 110 outputs the first path high-speed signal to the data collection card 20 in real time. The first delay chip 110 further generates a second path high-speed signal by delaying the first path high-speed signal in response to the delay command, and outputs the second path high-speed signal to the data collection card 20.

In step S306, the access control module 22 sends the data collection command to the asynchronous data collection module 24.

In step S307, the asynchronous data collection module 24 asynchronously collects the real-time high-speed signals and the delayed high-speed signals from the first to fourth delay chips 110 to 140, in response to the data collection command.

In step S308, the synchronous data collection module 25 synchronously collects the high-speed signals output from the asynchronous data collection module 24.

In step S309, the synchronous data collection module 25 transmits the high-speed signals to the storage module 27.

In step S310, the storage module 27 buffers the high-speed signals output from the synchronous data collection module 25. The storage module 27 stores the high-speed signals in various storage areas according to characteristics of the high-speed signals themselves. For example, when the high-speed signals (or the delayed high-speed signals, as the case may be) generated from the four signal sources 11 to 14 are respectively at a high level (1), a low level (0), a low level (0), and a high level (1), the storage module 27 stores the high-speed signals in a storage area having a storage address starting with 0x1001. In another example, when the high-speed signals generated from the four signal sources 11 to 14 are respectively at a low level (0), a high level (1), a high level (1), and a high level (1), the storage module 27 stores the high-speed signals in a storage area having a storage address starting with 0x0111.

In step S311, the access control module 22 retrieves the high-speed signals from the storage module 27, and transmits the high-speed signals to the data interface module 21. The data interface module 21 transmits the high-speed signals to the computer 30.

In step S312, the computer 30 stores the high-speed signals output from the data interface module 21, and processes the high-speed signals to extract the information carried by the high-speed signals.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. A signal collection system, comprising:
a computer;
a signal transmitting module comprising a signal source and a delay chip coupled to the signal source, wherein the signal source is adapted to output a first path high-speed signal to the delay chip; and
a data collection card interconnecting the computer and the signal transmitting module, wherein the data collection card is adapted to receive a delay command from the computer and transmit the delay command to the delay chip;
wherein the delay chip is adapted to generate a second path high-speed signal by delaying the first path high-speed signal in response to the delay command, the delay chip is further adapted to transmit the first path high-speed signal to the data collection card in real time and transmit the second path high-speed signal to the data collection card, and the data collection card is further adapted to transmit the first path high-speed signal and the second path high-speed signal to the computer.

2. The signal collection system of claim 1, wherein the data collection card comprises a data interface module connected to the computer, a delay control module connected to the delay chip, and an access control module interconnecting the data interface module and the delay control module; the data interface module is adapted to receive the delay command from the computer and transmit the delay command to the access control module; the access control module is adapted to receive the delay command from the data interface module and transmit the delay command to the delay control module; and the delay control module is adapted to receive the delay command from the access control module and transmit the delay command to the delay chip.

3. The signal collection system of claim 2, wherein the data collection card further comprises an asynchronous data collection module connected to the delay chip, and the asynchronous data collection module is adapted to asynchronously collect the first path high-speed signal and the second high-speed signal transmitted from the delay chip.

4. The signal collection system of claim 3, wherein the asynchronous data collection module is connected to the access control module, the data interface module is further adapted to receive a data collection command from the computer and transmit the data collection command to the access control module, the access control module is adapted to receive the data collection command from the data interface module and transmit the data collection command to the asynchronous data collection module, and the asynchronous data collection module is adapted to asynchronously collect the first path high-speed signal and the second high-speed signal transmitted from the delay chip in response to the data collection command.

5. The signal collection system of claim 3, wherein the data collection card further comprises a synchronous data collection module connected to the asynchronous data collection module, and the synchronous data collection module is adapted to synchronously collect the first path high-speed signal and the second high-speed signal transmitted from the asynchronous data collection module.

6. The signal collection system of claim 5, wherein the data collection card further comprises a storage module connected to the synchronous data collection module and the access control module, the storage module is adapted to buffer the first path high-speed signal and the second path high-speed signal transmitted from the asynchronous data collection module in corresponding storage areas of the storage module, the access control module is adapted to retrieve the first path high-speed signal and the second path high-speed signal from the storage module and transmit the first path high-speed signal and the second path high-speed path to the data interface module, and the data interface module is adapted to receive the first path high-speed signal and the second path high-speed signal from the access control module and transmit the first path high-speed signal and the second path high-speed signal to the computer.

7. The signal collection system of claim 5, wherein the data collection card further comprises a clock module connected to the asynchronous data collection module and the synchronous data collection module, and the clock module is adapted to generate clock signals with a uniform clock frequency and output the clock signals to the asynchronous data collection module and the synchronous data collection module.

8. The signal collection system of claim 2, wherein the data interface module is a universal asynchronous receiver/transmitter (UART).

9. The signal collection system of claim 1, wherein the signal transmitting module further comprises a second signal source and a second delay chip coupled to the second signal source and to the first delay chip, the first delay chip is further adapted to transmit the delay command to the second delay chip, and the second delay chip is adapted to delay a third path high-speed signal output from the second signal source in response to the delay command.

10. The signal collection system of claim 2, wherein the data collection card comprises one of a complex programming logic device (CPLD) and a field programmable gate array (FPGA).

11. A signal collection method, comprising:
outputting a first path high-speed signal to a delay chip;
transmitting the first path high-speed signal to a data collection card in real time by the delay chip;
receiving a delay command from a computer, and transmitting the delay command to the delay chip by the data collection card;
generating a second path high-speed signal by delaying the first path high-speed signal, by the delay chip in response to the delay command;
transmitting the second path high-speed signal to the data collection card by the delay chip;
receiving both the first path high-speed signal and the second path high-speed signal transmitted from the delay chip, by the data collection card;
transmitting the first path high-speed signal and the second path high-speed signal to the computer by the data collection card; and
receiving and processing the first path high-speed signal and the second path high-speed signal transmitted from the data collection card, by the computer.

12. The signal collection method of claim 11, further comprising:
receiving a delay command from the computer by a data interface module of the data collection card;
transmitting the delay command to an access control module of the data collection card by the data interface module; and
transmitting the delay command to the delay chip by the access control module.

13. The signal collection method of claim 12, further comprising asynchronously collecting the first path high-speed signal and the second high-speed signal transmitted from the delay chip by an asynchronous data collection module of the data collection card.

14. The signal collection method of claim 13, further comprising:
receiving a data collection command from the computer by the data interface module;
transmitting the data collection command to the access control module by the data interface module; and
transmitting the data collection command to the asynchronous data collection module by the access control module, wherein the asynchronous collection is performed by the asynchronous data collection module in response to the data collection command.

15. The signal collection method of claim 13, further comprising synchronously collecting the first path high-speed signal and the second high-speed signal transmitted from the asynchronous data collection module by a synchronous data collection module of the data collection card.

16. The signal collection method of claim 15, further comprising:
buffering the first path high-speed signal and the second path high-speed signal in corresponding storage areas by a storage module of the data collection card;
retrieving the first path high-speed signal and the second path high-speed signal from the storage module by the access control module;
transmitting the first path high-speed signal and the second path high-speed signal to the data interface module by the access control module; and
transmitting the first path high-speed signal and the second path high-speed signal to the computer by the data interface module.

17. The signal collection method of claim 15, further comprising generating clock signals with a uniform clock frequency and outputting the clock signals to the asynchronous data collection module and the synchronous data collection module, by a clock module of the data collection card.

18. The signal collection method of claim 12, wherein the data interface module is a universal asynchronous receiver/transmitter (UART).

19. The signal collection method of claim 11, further comprising:
transmitting the delay command to a second delay chip by the first delay chip; and
delaying a third path high-speed signal output from a second signal source of the signal transmitting module, by the second delay chip in response to the delay command.

20. The signal collection method of claim 11, wherein the data collection card comprises one of a complex programming logic device (CPLD) and a field programmable gate array (FPGA).
